(19) United States
(12) Patent Application Publication
(10) Pub. No.: US 2006/0180130 A1
(43) Pub. Date: Aug. 17, 2006

(54) Motor assisted mechanical supercharging system

(76) Inventor: David St. James, Santa Barbara, CA (US)

Correspondence Address: GENE W. ARANT, P.O. BOX 269, LINCOLN CITY, OR, 97367-0269, US

(21) Appl. No.: 11/349,768

(22) Filed: Feb. 7, 2006

Related U.S. Application Data
(60) Provisional application No. 60/652,264, filed on Feb. 14, 2005.

(51) Int. Cl. F02B 33/00

(52) U.S. Cl. 123/559.1

(57) ABSTRACT

Internal combustion engine with a centrifugal compressor or positive displacement air supercharger incorporating a high speed electric motor on the drive shaft for the purpose of acceleration and generation of pressurized air at low engine speeds and incorporation of one-way and/or magnetic clutches for efficient operation.

### CROSS REFERENCE TO RELATED APPLICATION

This application claims the priority of my Provisional application, Ser. No. 60/652,264, filed Feb. 14, 2005.

### FIELD OF INVENTION

This invention relates generally to intake air charging systems for internal combustion engines.

### BACKGROUND OF THE INVENTION

Application of superchargers in internal combustion engines, whereby pressurized air is generated by means of a centrifugal compressor or a positive displacement air pump such as a roots blower, have been in practice for many years. The power to operate the supercharger is obtained from the engine itself, by means of a belt and pulley arrangement or direct gear drive.

Supercharging enables the engine to generate more power by means of a higher volume of air being fed to the engine under pressure and corresponding adjustment to fuel flow. It is not uncommon to increase engine power by 50% or higher with the aid of a supercharger, proportional to the pressure of boosted air, which is also proportional to the rotational speed of the supercharger. Therefore, the faster the engine turns, the faster the supercharger speed and therefore higher air pressure and more power is generated.

The drawback of supercharging, however, is the fact that many vehicles need maximum power during acceleration from stand still, such as at a traffic light. In such instances, the engine is running at low idle speed, which in turn is rotating the supercharger at a low speed, resulting in very low air pressure. It is not until the engine speed increases that an appreciable increase in power can be realized. Although generation of power at high engine speeds is beneficial for high vehicle speeds and heavy load carrying applications, the lack of increased power during acceleration is a serious drawback, particularly in applications with a diesel engine when reduced air flow during acceleration results in emission of black smoke.

It would therefore be of great value if a supercharger could generate maximum boost of intake air pressure during low engine speeds and throughout the acceleration run of the vehicle.

### SUMMARY OF THE INVENTION

The present invention addresses the low air pressure problem during low engine speeds by drivingly coupling an electric motor to the drive shaft of the compressor in the supercharging system. During low engine speeds the electric motor will accelerate the compressor to an optimum speed so that high pressure air can be generated for increasing the engine power during acceleration of the vehicle.

Once the vehicle has attained the desired speed together with high engine speed, the electric motor may be switched off so that the engine will then power the compressor by means of a belt or gear drive for continuous operation. The functioning of the electric motor may be controlled by switches in the accelerator pedal, signals from an engine management system, or from other sensors.

A one-way clutch and/or a magnetic clutch placed between the compressor drive shaft and the pulley for the belt drive or gear for a gear drive, will disconnect the compressor drive shaft from the engine so that the electric motor can freely accelerate the compressor to optimum speed. Once the electric motor has been switched off, the one-way clutch will engage so that engine power will drive the compressor for sustained high power operation.

As another feature of the invention, when the load of the compressor has been picked up by the engine power, the electric motor, rather than being switched out of operation, may have its electronic controls switched so that it will then generate electricity to go back into the electrical system.

Under low load conditions, the magnetic clutch can also be used to disconnect the compressor from the engine for the purpose of reducing parasitic drag on the engine, and the electric motor drive is switched off.

### BRIEF DESCRIPTION OF DRAWINGS

FIG. 1—is a schematic drawing of an engine and various components incorporating a motor assisted supercharger system.

FIG. 2—is a schematic drawing of the present invention incorporating a centrifugal compressor, gear drive, magnetic clutch, electric motor, and multiple possible locations of a one-way clutch.

FIG. 3—is a schematic drawing of the present invention incorporating a centrifugal compressor, gear drive, electric motor, and possible one-way clutch locations.

FIG. 4—is a schematic drawing of a drive pulley engine output, a magnetic clutch, a roots type positive displacement compressor, an electric motor drivingly coupled to the compressor, and possible one-way clutch locations.

FIG. 5—is a schematic drawing of a presently preferred form of the invention incorporating a centrifugal compressor, electric motor, power electronics for operation of the electric motor, and different alternative locations for the one-way clutch, gear drive, magnetic clutch and belt pulley.

FIG. 6—is a schematic drawing of an air intake system incorporating an independent air by-pass flapper valve for use with an electric motor assisted supercharger system.

FIG. 7—is a schematic drawing of an electric motor assisted compressor incorporating an integral passive air by-pass flapper valve.

FIG. 8 is a cross-sectional view of a compressor arrangement showing an alternate location for the electric motor of the present invention.

### MODES OF OPERATION

According to one form of the apparatus of the invention there are four separate and distinct modes of operation.

In one mode of operation the electric motor is used to boost the air pressure in the cylinders, whether the engine is not yet started or is already running, but at low speed.

In a second mode of operation the electric motor is used to raise air pressure in the cylinders before the engine is started. Once the engine is started and when the engine speed picks up sufficiently it acts through a clutching mechanism to pick up the compressor load, and the electric motor is then made to be inactive.

In a third mode of operation the electric motor is used to raise air pressure before and during the starting of the engine. When the engine is started and picks up the compressor load from the electric motor, the circuit connections for the motor are automatically modified by the engine management system so that it becomes a generator and feeds power back into the electrical system.

In a fourth mode of operation the electric motor is not involved at all because the engine operator has not had a need to utilize the supercharging capability of the compressor.

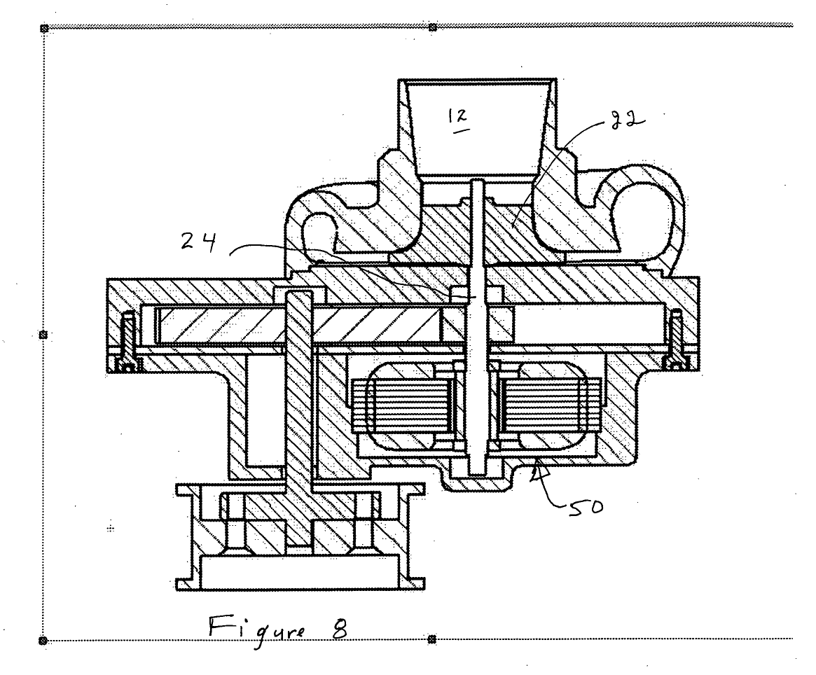

In the form of apparatus as illustrated in FIG. 8 it is possible for the power output from the engine to bypass the compressor entirely. Then the engine power may be used to directly drive the motor as an alternator.

### DETAILED DESCRIPTION OF THE INVENTION

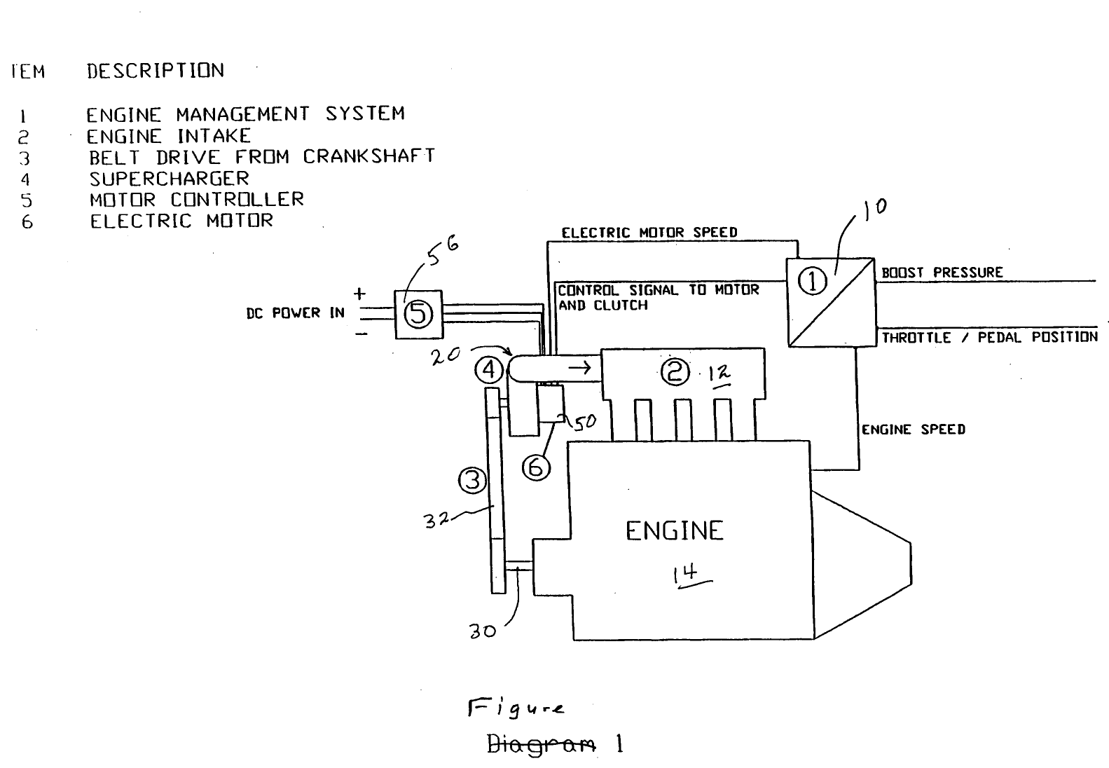

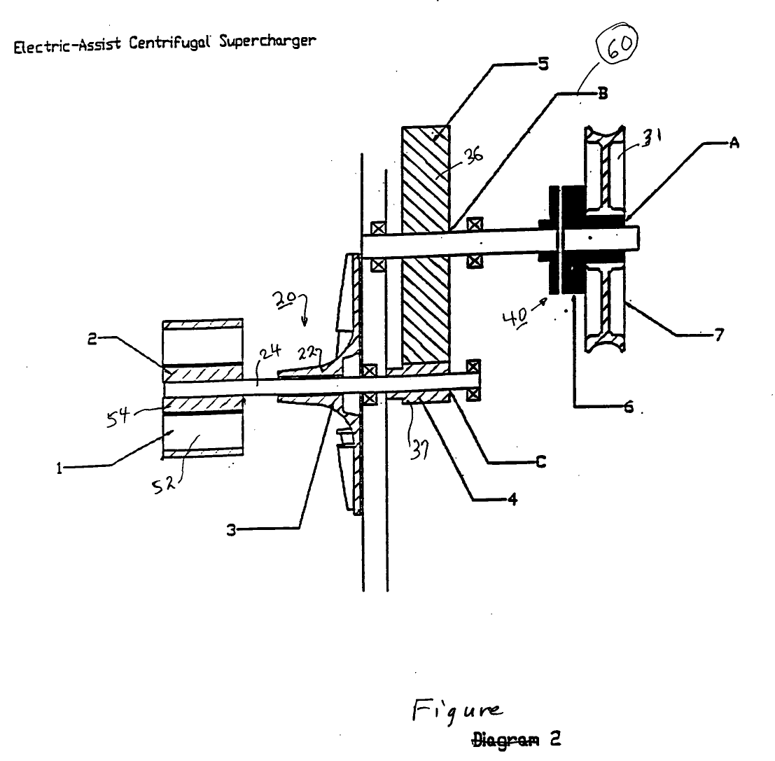

### Drawing FIGS. 1-7

The invention is illustrated in the context of an internal combustion engine having an engine management system 10, an air intake 12 for the engine, and an engine 14. A compressor assembly 20 includes a compressor 22, supported on a compressor drive shaft 24. A by-pass valve 26 is optional for use with the compressor.

In accordance with standard engine practice, there is a rotating drive mechanism 30 which delivers rotary power from the engine output to compressor shaft 24. The rotating drive includes a pulley wheel 31 driving a belt 32. Belt 32 in turn drives a gear train 35 which includes a spur gear 36 and a pinion gear 37.

In the embodiment of FIGS. 1-7 a magnetic clutch 40 is placed at a desired location in the rotating drive mechanism 30 for the purpose of selectively turning on the compressor operation. As is well known, the magnetic clutch can be quickly activated to maintain the driving relationship of the successive portions of the drive mechanism, or may be quickly activated to disengage them. Thus, it becomes an “on-off” switch for the compressor.

Electric motor 50 energized from battery 14 is selectively used under control of the engine management system 10 for driving the compressor 22. The motor has a stator winding 52 and a rotor 54. A separate motor controller 56 is shown in some of the drawing figures.

A one-way clutch 60 is preferably located intermediate to the magnetic clutch 40 and compressor 22 in the drive mechanism 30. The purpose of one-way clutch 60, which may be a typical mechanical over-running clutch, is to permit the output power from the engine to pick up the compressor load by driving the compressor faster than it is being driven from the electric motor.

In the preferred embodiment an electric motor without any permanent magnet in its construction such as an induction motor and preferably a variable reluctance motor is incorporated. Magnets are generally sensitive to heat, and in the hot engine environment there is always the danger of magnets becoming demagnetized due to heat.

Furthermore, the rotor assemblies of permanent magnet motors are prone to failure at high speed. Incorporation of rotors with permanent magnets would also require additional one way clutching for operational modes when the electric motor is switched off but the compressor is turning under power from the engine, whereby rotation of the rotor with the magnets at motor off mode can generate excessive heat due to electromagnetic losses. Therefore, a switch reluctance motor which generates maximum torque during acceleration, and has no permanent magnets in its construction, is the preferred choice for this invention.

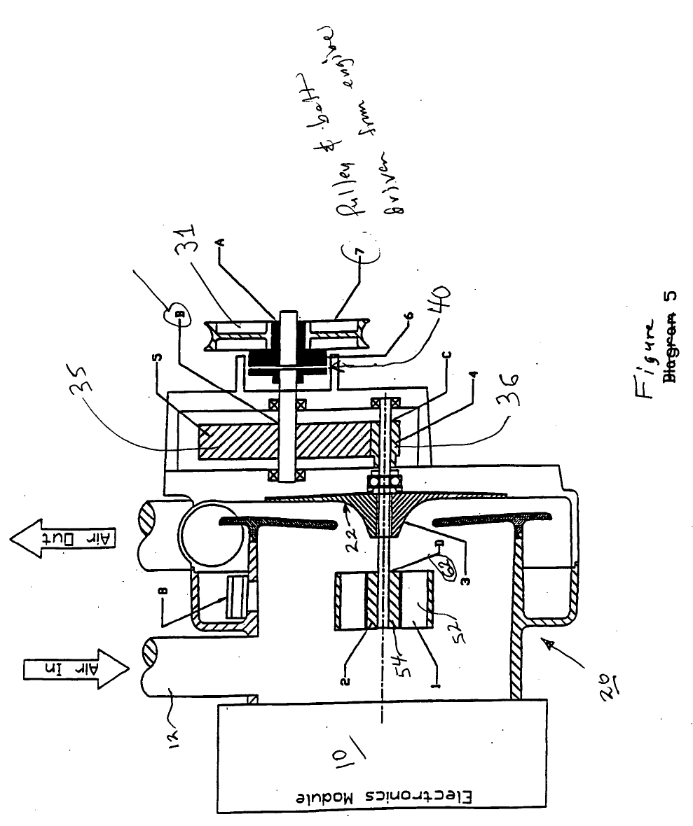

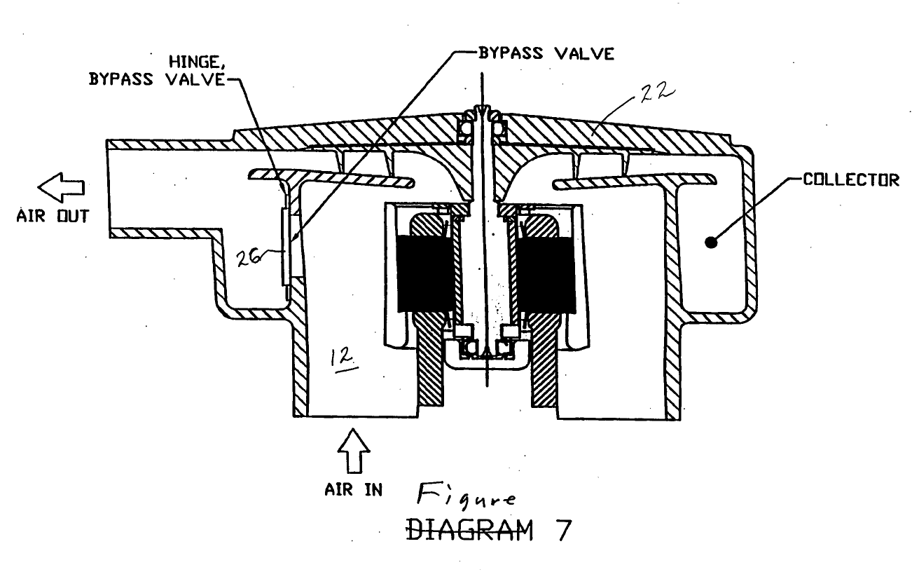

In a preferred embodiment as specifically shown in FIGS. 5 and 7, an electric motor of the variable reluctance type is employed.

In applications with two stroke engines whereby pressurized air is needed for starting of an engine, the electric motor is activated upon turning the ignition to the on position prior to cranking the engine. This starting mode is also applicable to cold starting of a diesel engine, whereby in cold weather conditions warm intake air is needed. The benefit of this feature is that by activating the motor, intake air flows through the supercharger past the electronic module and the motor winding, whereby the air absorbs heat and then the process of pressurization of the air, will further increase the temperature of the air in the cylinders and thereby facilitate engine starting of the engine.

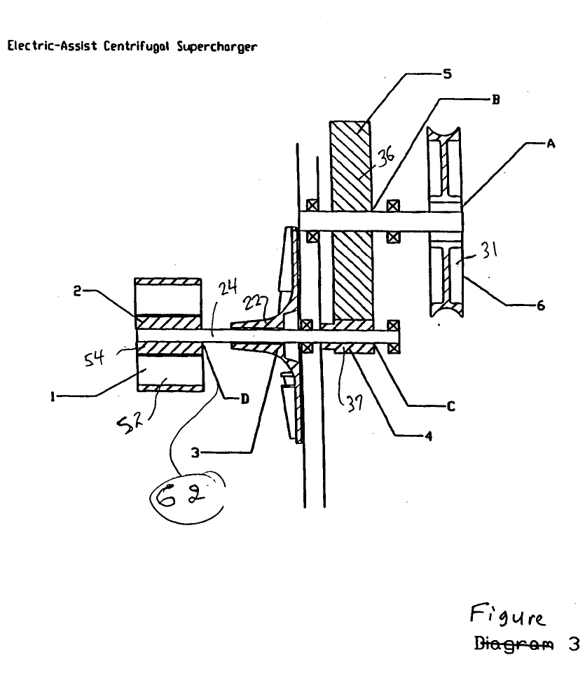

In other operational modes, the engine is started with the electric motor in the off position. Once the gear is engaged and the accelerator pedal is depressed, the electric motor receives a signal from the engine management system and is energized, speeding up the compressor wheel in less than one second and supplying the engine with pressurized air for the initial rapid acceleration. During this mode, the one-way clutch in any of positions “A”, “B”, or “C” of FIG. 3 or 5 will enable the electric motor to accelerate to its maximum speed, without having to rotate the pulley and belt arrangement. As the engine speed builds up, so that the engine speed multiplied by the belt and pulley speed multiplication and gear drives can take over rotation of the compressor wheel, the magnetic clutch is engaged and the electric motor is switched off, so that the engine can continue to drive the compressor.

The engine management system can be programmed to disengage the supercharger during low engine power demand periods such as slow speed cruising in order to reduce parasitic drag from the supercharger on the engine.

By programming the engine management system, the electric motor can be re-energized at any time that demand for more power is made and the engine is turning at a low speed so that the cycle can be repeated. If demand for power is made and the engine speed is high enough for generation of sufficient boost, then the engine management system can by-pass activation of the electric motor and instead engage the clutch to drive the compressor.

The unit may also incorporate an integral passive by-pass valve 26. The by-pass valve will allow unrestricted air flow to the engine while the compressor is not in operation. This feature will eliminate any restriction of air flow through the compressor wheel when the unit is off. The integral valve 26 as shown, is a hinged piece of metal or plastic which is placed between the air intake passage and the compressor wheel collector.

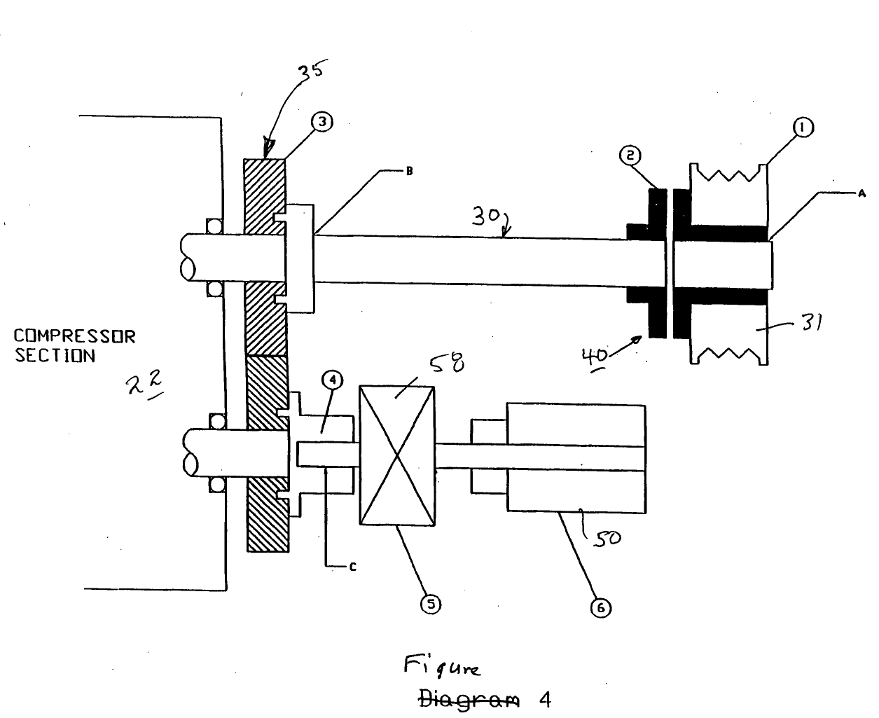

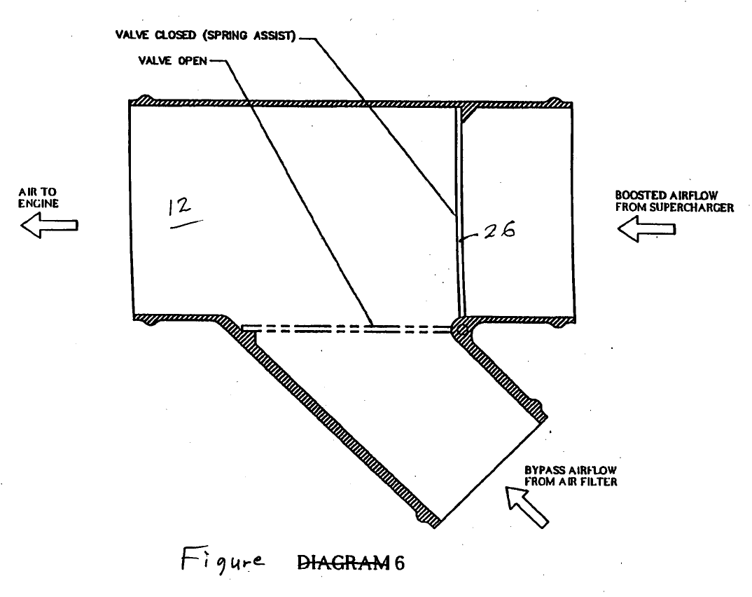

Alternatively, in an application such as using a roots type blower in FIG. 4, an external by-pass valve as shown in FIG. 6 or 7 can be incorporated in the engine air intake system so that unrestricted air can enter the engine when the compressor is off, or when the engine is drawing more air at higher speeds than the compressor can provide.

### Alternate Embodiment (FIGS. 3, 5 and 8)

FIGS. 3 and 5 show an alternative embodiment of the present invention of motor assisted compressor without incorporation of a magnetic clutch. This embodiment eliminates the cost of a magnetic clutch; however, the compressor is always connected to the engine crankshaft by means of the belt and pulley arrangement. This embodiment is suitable for applications such as trucks or marine applications when sustained high power demand are needed. In this application the electric motor will rapidly speed up the compressor, independent of the belt and pulley arrangement, incorporating a one-way clutch in positions “A”, “B”, or “C” of FIGS. 3 and 5. In the apparatus of FIGS. 3 and 5 the operational polarity of the one-way clutch 62 is reversed relative to that shown in other drawing figures. This one-way clutch permits operation of the compressor under engine power without rotation of the electric motor rotor and generation of drag and heat, while the motor is off. The one-way clutch 62 is needed in position “D” when an electric motor incorporating permanent magnets is used.

FIG. 8 shows an alternate form of the invention in which the electric motor may be used to assist in starting the engine but when the engine power picks up the compressor load, the electric motor is not then deactivated. Instead, its electrical circuit connections are automatically modified under control of engine management system 10 so that it acts as a generator or alternator, delivering power back into the electrical system.

The explanations of the preferred embodiment and other alternative arrangements are for the purpose of illustration only and not a limitation of various alternative embodiments and their operation mode with an engine.

What i claim is:

1. In an internal combustion engine having an air intake and an engine output adapted to provide rotary power, a supercharging system comprising:
a compressor having a shaft, the compressor being adapted to provide an auxiliary air flow into the air intake of the engine;
drive means coupling the engine output to the compressor shaft, the drive means including a magnetic clutch adapted to selectively engage or disengage the compressor, a gear drive train drivingly coupling the magnetic clutch to the compressor, and a one-way clutch located in the gear drive train intermediate to the magnetic clutch and the compressor;
a vehicle battery;
an electric motor energized from the battery and having a rotary output drivingly coupled to the compressor shaft;
a control adapted to selectively operate the motor so that the compressor will be rotatably driven from the motor output; and
the one-way clutch being operable to allow the compressor to be rotatably driven faster from the electric motor than the gear train would drive it from the engine output alone.

2. In a supercharged engine having an air intake channel, a compressor in the air intake channel, and a drive train coupling the engine output power to the compressor, the improvement comprising:
an electric motor coupled to the compressor and selectively operable for drivingly rotating the compressor either before the engine has been started, or after the engine has been started but is not yet running at full speed;
a drive train having a one-way clutch coupling the engine output to the compressor; and
the clutch being operable at some speed greater than the engine starting speed to allow power from the engine output to overtake the driven rotation of the compressor from the electric motor.

3. An engine as in claim 2 wherein the clutch is a mechanical over-running clutch.

4. An engine as in claim 2 wherein the drive train also includes an electromagnetic clutch to selectively disable the compressor drive from the engine, the one-way clutch being located intermediate to the magnetic clutch and the compressor.

5. In an internal combustion engine having a combustion air input, an output shaft, a compressor for selectively supplying air at above atmospheric pressure to the air input, the compressor having an input, and a power train for selectively coupling the engine output shaft to the compressor input;
a method of enhancing engine performance comprising the steps of:
providing an auxiliary electric motor having an output shaft drivingly coupled to the compressor input;
before the engine is turned on, starting the motor;
thereafter starting the engine and coupling the engine through its power train to the compressor power input; and
then de-coupling the electric motor drive from the compressor after the engine output power has picked up the drive of the compressor input.

6. The method of claim 5 wherein the de-coupling of the electric motor drive is accomplished through a mechanical one-way clutch.

7. In an automotive engine system having an engine with a rotary power output, an electronic engine management system, a compressor with a compressor drive shaft, and an auxiliary electric motor, the method of operation comprising the steps of:
a. drivingly coupling the electric motor to the compressor drive shaft to produce an auxiliary flow of intake air for the engine;
b. then drivingly coupling the power output of the engine to the compressor shaft to further increase the compressor speed to and beyond that previously achieved in response to the electric motor drive; and
c. thereafter, instead of de-activating the motor operation, utilizing the electronic engine management system to switch the electrical connections of the motor so that it operates as a generator of electrical power corresponding to a portion of the mechanical output energy from the engine.

8. The method of claim 7 wherein a one-way clutch is utilized in the drive coupling between the engine and the compressor shaft so that the rotating speed of the compressor shaft may initially over-run the speed that could be imparted to it from the engine power output.

9. The method of claim 7 wherein an electric motor of the switch reluctance type is utilized.

10. The method of claim 8 wherein an electric motor of the switch reluctance type is utilized.
